(19) United States
(12) Patent Application Publication
(10) Pub. No.: US 2021/0354991 A1
(43) Pub. Date: Nov. 18, 2021

(54) Malleable Ceramics

(71) Applicant: Melvin Keith Carter, Lincoln, CA (US)

(72) Inventor: Melvin Keith Carter, Lincoln, CA (US)

(21) Appl. No.: 16/876,346

(22) Filed: May 18, 2020

(51) Int. Cl. C01B 33/20

(52) U.S. Cl. CPC C01B 33/20

(57) ABSTRACT

The malleable ceramics taught in this application are formed from silica or silicon dioxide and transition metal compounds comprising titanium dioxide, iron (II) oxide, manganese (II) oxide, cobalt (II) oxide (MO) or salts thereof in a process of sintering or melting together in a suitable crucible within a specific mol ratio. The selected M/Si mol ratio comprises 1.6/1.0 to 1.9/1.0.

These materials sinter above 1,100° C., where sintered parts exhibit densities near 3 grams/cubic centimeter and melt at higher temperatures. Thus, these materials form in a temperature range comprising 1,100° C. to 1,800° C. Malleable ceramic materials prepared as described herein deform when struck firmly with a hammer and do not fracture. Repeated striking increases the deformation or denting just like a piece of low alloy steel.

### REFERENCES CITED

U.S. Patent Documents

| Pat. No. | Issue Date | Author | Comments |
|---|---|---|---|
| 7,579,084 | Aug. 25, 2009 | E Saleh | Ceramic material, compositions and methods for |
| | | | manufacture an engobe clay composition, sanitary ware |
| | | | and methods of productions thereof. |
| 5,965,057 | Oct. 12, 1999 | K Hase, H Takagi, | A piezoelectric ceramic is a composite oxide of at least |
| | | A Ando, A Nagai, | lead, zirconium and titanium, wherein a glass oxide of |
| | | Y Tokuda, K Hayashi | manganese exists in a grain boundary layer in a density |
| | | | higher than that in a crystal grain. |
| 5,658,838 | Aug. 19, 1997 | T R Trabelsi | Alumina-based ceramic composition with a spinel-type |
| | | | aluminate phase for use as a water faucet seal. |
| 5,431,109 | Jul. 11, 1995 | E Berdut | Levitation and linear propulsion system using ceramic |
| | | | permanent magnets and interleaved malleable steel. |
| | | | A magnetic composed of groups of ceramic magnets being |
| | | | separated by a malleable steel member to focus the lines of |
| | | | magnetic flux. A second plurality of groups of ceramic |
| | | | magnets are positioned adjacent to a first plurality of such |
| | | | groups of ceramic magnets with opposite poles of the |
| | | | magnets facing each other. Those forces of attraction are |
| | | | used to cause levitation of a vehicle such as a train. |

### BACKGROUND

### Field of Invention

This disclosure teaches a process for formation of malleable ceramics. These specialty materials may be used in construction, insulation, roofing and plumbing since they do not fracture, rot or corrode.

Ceramic materials are inorganic, non-metallic solids prepared by the action of heat to sinter or melt the solids. Ceramic materials may be crystalline, partly crystalline or amorphous such as a glass. They have the characteristics of being hard and brittle often used as insulators, art objects and sanitary appliances. Ceramic products are usually divided into four sectors. These include structural materials, including bricks, pipes, floor and roof tiles, refractory materials, such as kiln linings, gas fire radiant materials, steel and glass making crucibles, white wares, including tableware, wall tiles, pottery products, and sanitary ware, and engineering products such as tiles used in the Space Shuttle program, gas burner nozzles, ballistic protection, nuclear fuel uranium oxide pellets, bio-medical implants, part of turbine jet engines, and missile nose cones.

Malleable ceramics have these same characteristics and similarities but are not brittle and do not shatter or break easily on impact. Instead, they deform like metals but melt as ceramics at high temperatures.

### Description of Prior Art

Malleable ceramic materials are of interest, in concept, as a replacement for metals such as steel that corrodes, internal combustion engine parts that can wear and etch, and wood that can rot. Further, production of relatively inexpensive malleable ceramics could find widespread use as a replacement for construction lumber, aluminum beams and roof tiles. A search of the prior art produced no entries for malleable ceramics but did produce entries for ceramics associated with transition metal compounds including titanium dioxide, iron or manganese oxide in combination with clay oxide materials including silicon or aluminum oxide. U.S. Pat. No. 7,579,084, issued Aug. 25, 2009, discloses a ceramic material, compositions and methods for manufacture using an engobe clay composition. Resulting products in which iron silicate could find use were sanitary ware. U.S. Pat. No. 5,965,057, issued Oct. 12, 1999, teaches production of a piezoelectric ceramic as a composite oxide of at least lead, zirconium and titanium, wherein a glass oxide of manganese exists in a grain boundary layer in a density higher than that in a crystal grain. U.S. Pat. No. 5,658,838, issued Aug. 19, 1997, reveals an alumina based ceramic composition with a spinel-type aluminate phase wherein up to two percent manganese oxides may be included for use as a water faucet seal. U.S. Pat. No. 5,431,109, issued Jul. 11, 1995, describes levitation and linear propulsion systems using ceramic permanent magnets and interleaved malleable steel. A magnet thereof is composed of groups of ceramic magnets, having a plurality of compositions, separated by a malleable steel member to focus the lines of magnetic flux. A second plurality of groups of ceramic magnets is positioned adjacent to a first plurality of such groups of ceramic magnets with opposite poles of the magnets facing each other. Those forces of attraction are used to cause levitation of a vehicle such as a train. This prior art relates to various ceramic compositions but does not teach malleable ceramics, their composition or means of producing them.

### SUMMARY OF THE INVENTION

This invention discloses a process for preparation of malleable ceramic materials, using transition metal salts or their oxides and silica or silicates in specified mol ratios, at elevated temperatures.

It is an object of this invention, therefore, to provide processes for formation of malleable ceramics. Other objects of this invention will be apparent from the detailed description thereof which follows, and from the claims.

### DETAILED DESCRIPTION OF THE INVENTION

Ceramics are materials having physical characteristics different from metals. Common ceramics are not electrically or thermally conductive, they readily fracture and break under applied stress rather than being malleable and are not composed of a single element. Ceramic materials are typically hard and are good insulators. Malleable ceramics are therefore a dichotomy in that, while they are not electrically or thermally conductive and are not made of a single element, they do not readily fracture under applied stress. The malleable ceramics disclosed in this application are formed from common silica combined with transition metal compounds comprising titanium dioxide, iron oxide, manganese oxide, cobalt oxide or salts thereof.

Iron silicate can be prepared from iron salts comprising iron(II) chloride or iron(II) sulfate by mixing together aqueous solutions of hydrated iron(II) chloride and sodium silicate or sodium hydrogen silicate in a Fe/Si mol ratio comprising 1.6/1.0 to 1.9/1.0. The solid that forms can be filtered, rinsed and dried. Heating the resulting dried iron silicate in the temperature range of 1,100° C. to 1,800° C. forms a malleable ceramic. It may also be formed by heating a uniform mixture of iron (II) oxide and silica in the same mol ratio. Malleable ceramic materials comprising titanium silicate materials, manganese silicate materials, iron silicate materials or cobalt silicate materials are also formed by these methods. Product formation occurs in air as no inert or other gases are required other than gases used to protect furnace heating elements.

Ceramic materials may be formed by sintering although melting produces a product of higher density. Sintered iron silicate malleable ceramic materials exhibited higher than typical ceramic densities near 3.0 grams/cubic centimeter whereas common ceramics possess densities more in the range of 2.2 to 2.4 grams/cubic centimeter. Manganese silicate malleable ceramic materials also exhibited higher than normal densities. Ceramic materials prepared as described herein deform when struck firmly with a hammer. Repeated striking increases the deformation or denting just like a piece of low alloy steel. A repeatedly struck piece can splay and fracture on its end without chipping or breaking. These materials can also be drilled or cut like low alloy steels. They do not corrode or oxidize as they are fully oxidized as prepared.

### PREPARATION EXAMPLES

### Ceramic 1

A malleable ceramic material, iron silicate, may be prepared by mixing together 68.4 grams to 69.1 grams of iron (II) chloride tetrahydrate dissolved in pure water with 100.0 grams of sodium hydrogen silicate solution having a density of 1.397 grams/cubic centimeter. The resulting precipitate was filtered, rinsed with pure water and heated at 125° C. or higher until dry. The malleable ceramic was formed by heating the dry iron silicate material at 1,100° C. to 1,650° C. in a suitable crucible for at least 15 minutes. The sintered material formed near 1,100° C. while the molten material formed above 1,600° C.

Upon cooling the sintered material was a non-crystalline solid, brown in color having a measured density of 2.97 grams/cubic centimeter. Upon striking with a hammer the solid displayed a dent but no fractures or chips.

### Ceramic 2

A malleable ceramic material, manganese silicate, may be prepared by mixing together 124.1 grams of manganese (II) oxide and 60.1 grams of silicon dioxide. A malleable ceramic was formed by heating at 1,700° C. to 1,800° C. in a suitable crucible for at least 15 minutes.

### Ceramic 3

A malleable ceramic material, cobalt silicate, may be prepared by mixing together 131.1 grams of cobalt (II) oxide and 60.1 grams of silicon dioxide. A malleable ceramic was formed by heating at 1,700° C. to 1,800° C. in a suitable crucible for at least 15 minutes.

What is claimed:

1. A process for formation of malleable ceramic materials comprising sintering or melting together transition metal compounds, comprising titanium dioxide, iron (II) oxide, manganese (II) oxide, cobalt (II) oxide (MO) or salts thereof, in combination with silicon dioxide or compounds thereof in a selected M/Si mol ratio comprising 1.6/1.0 to 1.9/1.0 in a suitable crucible.

2. A process for formation of malleable ceramic materials comprising sintering or melting together transition metal compounds, comprising titanium dioxide, iron (II) oxide, manganese (II) oxide, cobalt (II) oxide (MO) or salts thereof, in combination with silicon dioxide or compounds thereof in a selected M/Si mol ratio comprising 1.6/1.0 to 1.9/1.0 in a suitable crucible in a temperature range comprising 1,100° C. to 1,800° C.

3. A process for formation of malleable ceramic materials comprising sintering or melting together transition metal compounds comprising titanium dioxide, iron (II) oxide, manganese (II) oxide, cobalt (II) oxide (MO) or salts thereof, in combination with silicon dioxide or compounds thereof in a selected M/Si mol ratio comprising 1.6/1.0 to 1.9/1.0 in a suitable crucible in a temperature range comprising 1,100° C. to 1,800° C., for which the cooled ceramic deforms under sharp impact from a hammer and does not fracture.
